(19) United States
(12) Patent Application Publication
(10) Pub. No.: US 2006/0220347 A1
(43) Pub. Date: Oct. 5, 2006

(54) Hitch storage device

(76) Inventor: Bryan Witchey, Cross Junction, VA (US)

Correspondence Address: WOOD AND EISENBERG, PLLC, 2121 Eisenhower Ave, Suite 200, Alexandria, VA, 22314, US

(21) Appl. No.: 11/391,458

(22) Filed: Mar. 29, 2006

Related U.S. Application Data
(60) Provisional application No. 60/667,907, filed on Mar. 29, 2005.

(51) Int. Cl. B60D 1/14

(52) U.S. Cl. 280/507; 280/511; 280/491.5

(57) ABSTRACT

A hitch storage device (100) including: a connecting member (120) having a first surface (220) and a second surface (240); a male hitch member (140) protruding outwards from and connected to the second surface (240); a female hitch member (160) connected to the second surface (240); and a hitch-securing member (180) attached to the female hitch member (160). The male hitch member (140) and the female hitch member (160) when looked at from above are perpendicular to each other. The maximum distance between the hitch-securing member (180) and the male hitch member (140) is a predetermined distance C_{MAX} so chosen to ensure that the hitch-securing member (180) cannot separate completely from the female hitch member (160).

### CROSS-REFERENCE TO RELATED APPLICATIONS

This application claims the benefit of priority from U.S. Provisional Patent Application Ser. No. 60/667,907, filed Mar. 29, 2005, the entire contents of which are incorporated herein by reference.

### STATEMENT REGARDING FEDERALLY SPONSORED RESEARCH OR DEVELOPMENT

Not Applicable.

### FIELD OF THE INVENTION

This invention is directed to a hitch storage device.

### BACKGROUND OF THE INVENTION

Many modern vehicles, such as trucks and sports utility vehicles (SUVs), make use of a tube type hitch receiver. When not in use, it is not uncommon for a hitch attached to such a hitch receiver to protrude some way beyond the vehicle's rear bumper. Hitches that stick out beyond the rear bumper can lead to injuries wherein a person may bump into the hitch and sustain injuries to legs and knees. A driver might forget that the attached hitch is protruding beyond the vehicle's rear bumper and may inadvertently hit another vehicle while reversing. Drivers of other vehicles may not notice the protruding hitch and make inappropriate contact thereby causing damage to both vehicles.

The problem presented, therefore, for many drivers is where to put the hitch to avoid mishaps. Some drivers decide to remove their vehicle's hitch and place it inside or elsewhere on the vehicle. Such a strategy often leads to other problems. For example, a hitch placed on the bed of a pick-up truck may roll about during road trips and cause damage to the bed of the pick-up truck. The hitch is easier to steal if left in the bed of a pick-up truck.

The driver might decide to remove the hitch and store it, for example, on or in his/her house or garden shed and be prepared to retrieve the hitch. If the driver is located some way from his home and finds he/she needs to use the hitch, this set of circumstances may require the driver to go to a vendor of hitches and purchase a new hitch for immediate use. A hitch is often greasy, and grease may be inadvertently transferred from the hitch and cause accidental soiling of carpet or furniture. Thus, there is a need for a hitch storage device that stores the hitch proximate to the vehicle's hitch receiver while negating the issue of the attached hitch protruding beyond the vehicle's rear bumper.

U.S. Pat. No. 6,203,048, issued Mar. 20, 2001 to Adair, describes a method and apparatus, including a combination linchpin stowage adapter, for positioning a ball mount member of most class 2, 3, & 4 trailer hitches in both an operating and non operating retracted position on a trailer hitch receiver mounted underneath a vehicle.

U.S. Pat. No. 6,149,181, issued to Biederman, describes a retractable hitch that stores away from view. The hitch consists of a hollow connector bar having an attachment end and a receiver end. The attachment end of the connector bar has an opening extending laterally through it. A mounting bar at the receiver end contains a storage chamber. A draw bar having a connector end and a hitch end fits within the connector bar. The connector end has an opening piercing it, and the hitch end has an end for connecting devices. A locking pin extends through the opening in the attachment end of the connector bar and the opening in the connector end of the draw bar. The locking pin locks in a first position for securing the draw bar in a first position for attaching devices and a second position for storing the connector bar within the storage chamber.

U.S. Pat. No. 6,832,709 B2, issued to Henry, describes a holder and method of use for storing a ball mount having a stem and a ball supported on the stem in a ball hitch in which the stem is slidably received within a receiver supported on a vehicle. The holder includes a pocket for slidably receiving the stem therein and mounting means for mounting the pocket on a supporting surface of the vehicle, for example a sidewall of a truck box. The use of a pocket with suitable mounting means for mounting to a supporting surface of the vehicle while securing the stem of a ball mount therein provides proper storage for ball mounts, which are not in use. The result is that potentially damaging or annoying sliding movement of the ball mounts within a moving vehicle can be prevented.

Patent Application Publication US 20020017770 A1, published to Parrish, describes a receptacle mounted at a predetermined location for storing various tow hitch apparatuses and assemblies. Behind the mounting surface, the area may be hollow such as a standard dwelling wall or solid such as a brick or concrete wall found in a basement. The '770 device may be mounted on a floor or wall of a vehicle storage compartment. The dimensions of the invention are such that it can in one embodiment receive the standard two-inch male connector and in other embodiments receive other standard male portions of a tow hitch apparatus. In particular, the invention is designed to receive the various racks that have become popular for carrying sports equipment. These rigid racks attach to the standard trailer hitch receptacle found on many vehicles.

### SUMMARY OF THE INVENTION

A hitch storage device (100), comprising: a connecting member (120) having a first surface (220) and a second surface (240); a male hitch member (140) protruding outwards from and connected to the second surface (240); a female hitch member (160) connected to the second surface (240); and a hitch-securing member (180) attached to the female hitch member (160). The male hitch member (140) and the female hitch member (160) when looked at from above are perpendicular to each other. The maximum distance between the hitch-securing member (180) and the male hitch member (140) is a predetermined distance C_{MAX} so chosen to ensure that the hitch-securing member (180) cannot separate completely from the female hitch member (160).

### BRIEF DESCRIPTION OF THE DRAWINGS

FIG. 1 is an environmental perspective view of the hitch storage device, according to the present invention.

FIG. 2 is a front perspective view of the hitch storage device, according to the present invention.

FIG. 3 is a rear perspective view of the hitch storage device, according to the present invention.

FIG. 4 shows a side view of a hitch storage device, according to the present invention.

FIG. 5A shows a side view of a hitch storage device, according to the present invention.

FIG. 5B shows a cross-section side view of a hitch storage device, according to the present invention.

FIG. 6 shows a section side view of a hitch storage device, according to the present invention.

FIG. 7 shows a side view of a hitch storage device inserted into a vehicle's hitch receiver, according to the present invention.

FIG. 8 shows a side view of a hitch storage device, according to the present invention.

FIG. 9 shows a side view of a hitch storage device, according to the present invention.

FIG. 10 shows a side view of a hitch storage device, according to the present invention.

FIG. 11 shows a side view of a hitch storage device, according to the present invention.

FIG. 12 shows a side view of a hitch-securing member, according to the present invention.

FIG. 13 shows a view of a hitch storage device in combination with a hitch and a vehicle's hitch receiver, according to the present invention.

Similar reference characters denote corresponding features consistently throughout the attached drawings.

### DETAILED DESCRIPTION OF THE PREFERRED EMBODIMENTS

This invention is directed to a hitch storage device. The hitch storage device of the invention is denoted generally by the numeric label “100”.

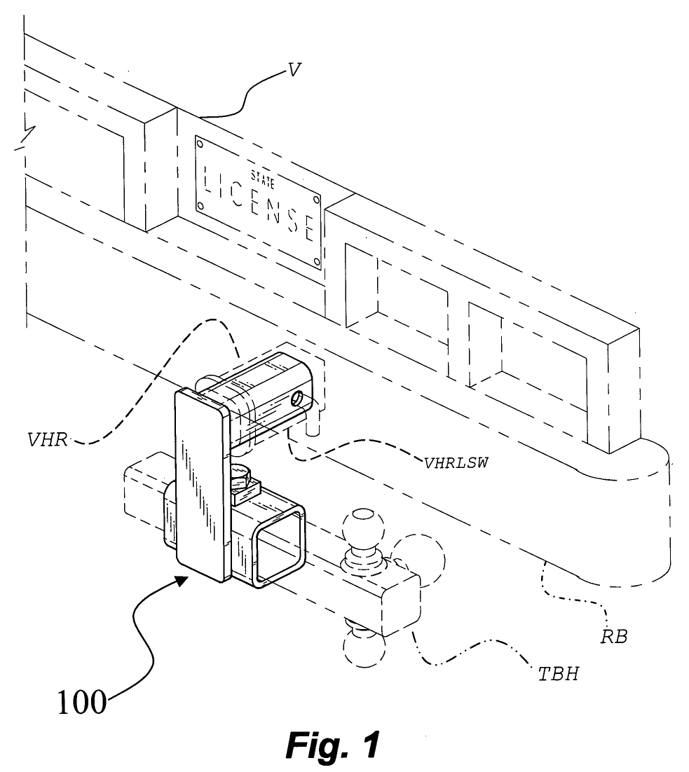

FIG. 1 is an environmental perspective view of a first embodiment of the hitch storage device 100. The hitch storage device 100 is shown attached to a vehicle V, and more particularly to the vehicle's hitch receiver VHR (shown in dashed lines) and to a standard tri-ball hitch TBH (also shown in dashed lines, the lower sidewall of the vehicle's hitch receiver VHR is represented by the label “VHRLSW”). More specifically, the tri-ball hitch TBH is shown stored in the hitch storage device 100 proximate to the vehicle's hitch receiver VHR and parallel to the vehicle's rear bumper RB thereby reducing the risk of someone coming into harmful contact with the tri-ball hitch TBH. It will be understood by a person of ordinary skill in the art that the hitch storage device 100 of the invention is expressly not limited to safely storing a tri-ball hitch TBH. The hitch storage device 100 can be used to safely store any kind of hitch designed to fit into a vehicle's hitch receiver VHR.

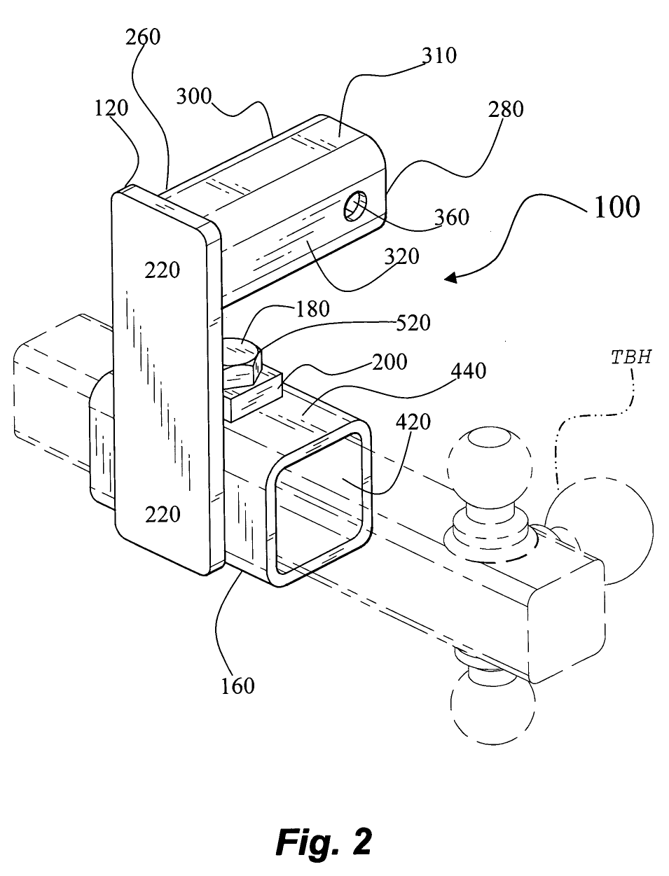

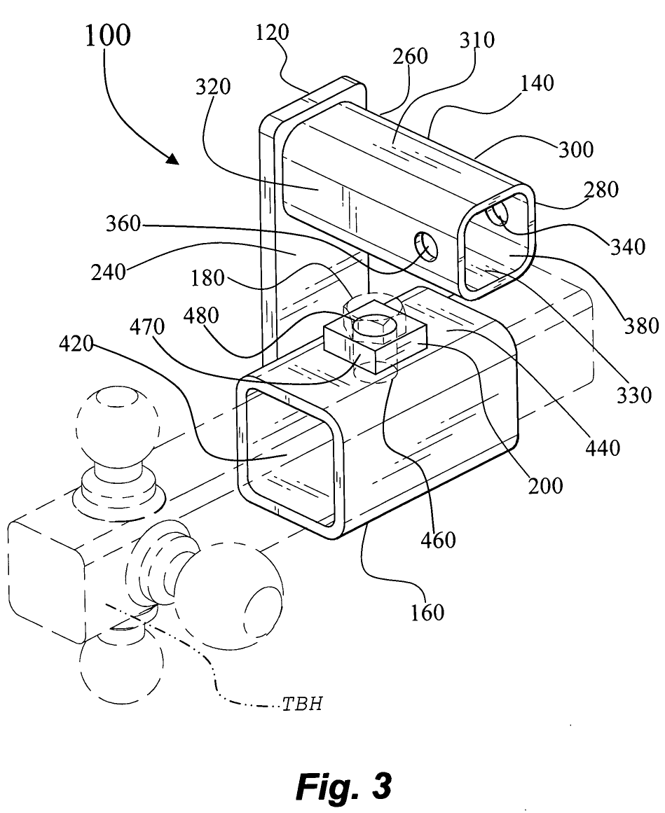

Referring to FIGS. 2 and 3, the hitch storage device 100 (shown in FIG. 1) comprises a connecting member 120, a male hitch member 140, a female hitch member 160, a hitch-securing member 180, and an optional stabilizer member 200. The connecting member 120 has a first surface 220 and a second surface 240. The male hitch member 140 comprises: a proximate end 260, a distal end 280, opposite first 300 and second 320 sidewalls, and opposite top 310 and bottom 330 sidewalls. The first 300 and second 320 sidewalls respectively define first 340 and second 360 horizontally aligned apertures.

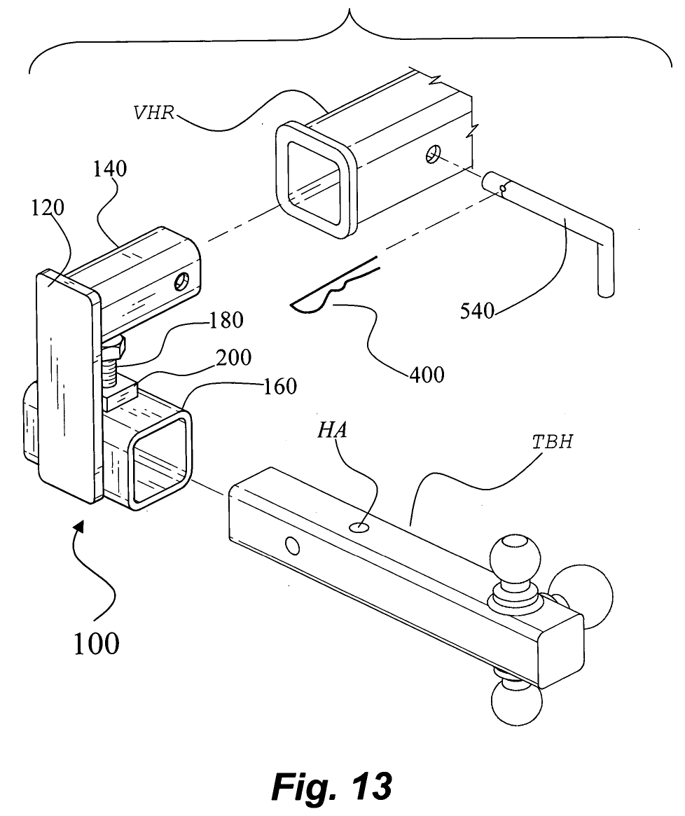

The male hitch member 140 is a tubular structure sized and shaped to fit inside a vehicle hitch receiver VHR (see FIGS. 1, 7 and 13). The male hitch member 140 is closed at its proximal end 260 and open at its distal end 280 with a hollow bore 380 disposed between the proximal 260 and distal ends 280. In the embodiment shown in FIGS. 2 and 3, the proximal end 260 is closed off by second surface 240 of connecting member 120. However, the male hitch member 140 can comprise a solid interior so long as a hollow bore is disposed between apertures 340 and 360 of suitable diameter to receive a securing bolt 540 (see FIG. 13) or its functional equivalent.

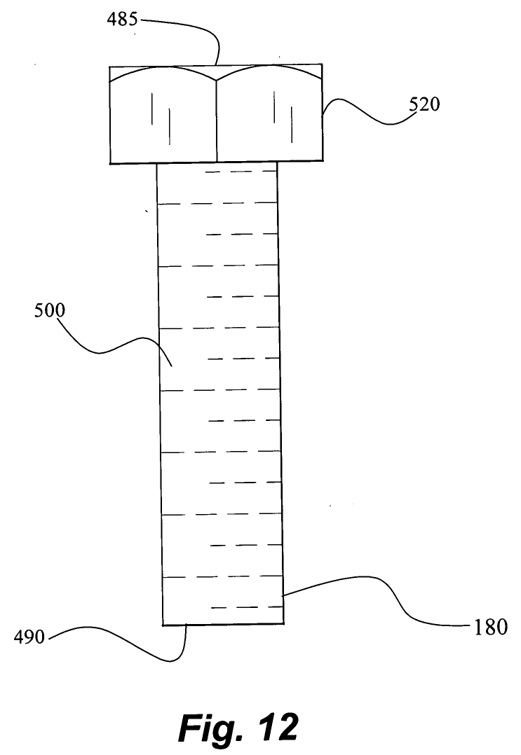

The hitch-securing member 180 comprises a top 485 and bottom 490, shaft 500 and a head section 520 (see FIG. 12). It will be understood by a person of ordinary skill in the art that the hitch-securing member 180 can take any suitable form and is not limited to a bolt comprising a shaft 500 and head section 520. Consequently, it will be understood that no matter what form the hitch-securing member 180 takes, it will have a top 485 and bottom 490.

Still referring to FIGS. 2 and 3, as noted above, the female hitch member 160 is used to store a hitch (represented in the FIGURES by tri-ball hitch TBH). The female hitch member 160 has a generally tubular shape and comprises a hollow bore 420 for receiving a hitch such as, but not limited to, tri-ball hitch TBH. The female hitch member 160 further comprises a top sidewall 440. The top sidewall 440 defines aperture 460. The hitch-securing member 180 fits through aperture 460.

If fitted, the optional stabilizer member 200 defines aperture 480. Apertures 460 and 480 define bore 470 sized to allow through-passage of shaft 500 of hitch-securing member 180. The diameter of the apertures 460 and 480 are approximately equal and slightly greater than the diameter of shaft 500. Optional stabilizer member 200 reduces horizontal wiggle of hitch-securing member 180.

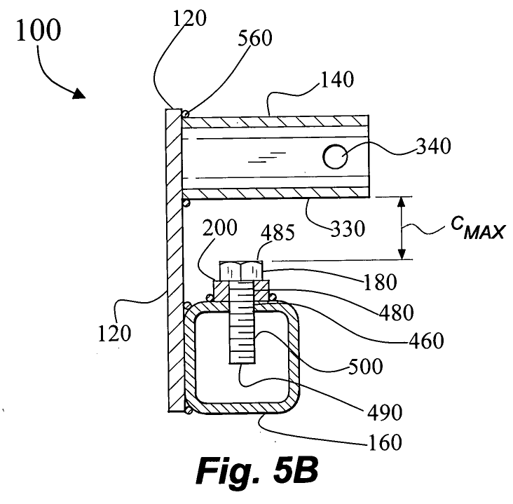

Referring to the FIGURES in general, and FIGS. 5B and 7 in particular, the design of the hitch storage device 100 ensures that the hitch-securing member 180 always remains part of the hitch storage device 100. Even if the hitch storage device 100 is shaken upside down, the hitch-securing member 180 will not fall out or otherwise depart from the device 100. This feature is useful because the vehicle owner need never search for a lost hitch-securing member 180. More specifically, the maximum clearance C_{MAX} (see FIG. 5B) between the bottom sidewall 330 of member 140 and the top 485 of the hitch-securing member 180 is less than the total length of the hitch-securing member 180 thereby preventing the hitch-securing member 180 from exiting bore 470 or, if optional stabilizer member 200 is not fitted, aperture 460 such that hitch-securing member 180 remains a permanent part of the hitch storage device 100.

C_{MAX} is also chosen to ensure easy removal of a stored hitch (such as, but not limited to, tri-ball hitch TBH) from female hitch member 160. Thus, when the hitch-securing member 180 is lifted up to touch or almost touch the bottom sidewall 330, the bottom 490 of shaft 500 is located inside combined bore 470 and not found inside bore 420 thus allowing easy removal of a stored hitch (such as, but not limited to, tri-ball hitch TBH) from the female hitch member 160. More specifically, when the hitch-securing member 180 is extended upwards to C_{MAX} or within C_{VHR} of the bottom sidewall 330, the bottom 490 of the hitch-securing member 180 is moved clear of bore 420 of female hitch member 160 but the bottom 490 of locking member 180 does not fully detach from the female hitch member 160 (see FIGS. 5B and 7) or, if fitted, the optional stabilizer member 200. The bottom 490 does not completely exit out of bore 470 even if the hitch storage device 100 is shaken vigorously and/or upside down. (Note: label “C_{VHR}” represents the thickness of the lower sidewall VHRLSW of a vehicle's hitch receiver VHR, see FIG. 7).

Once the bottom 490 of the hitch-securing member 180 is clear of the bore 420, a hitch (such as but not limited to, tri-ball hitch TBH) can be inserted or removed from the female hitch member 160. Hence, when a hitch is inserted and secured inside the female hitch member 160 and the hitch storage device 100 inserted and locked in a vehicle's hitch receiver VHR (see, e.g., FIG. 1), the hitch can not fall out or be removed from the hitch storage device 100 until the male hitch member 140 is removed from the vehicle's hitch receiver VHR and the hitch-securing member 180 lifted clear of aperture HA.

To secure a hitch inside female hitch member 160, the male hitch member 140 must be removed or clear of the vehicle's hitch receiver VHR to allow the hitch-securing member 180 to be lifted substantially clear of bore 420 to allow a hitch to be pushed inside the female member 160 and one of the hitch's apertures HA lined up with apertures 460/480 (i.e., bore 470) to allow the hitch-securing member 180 to drop down into an aperture HA to secure the hitch inside female hitch member 160. The hitch storage device 100 (or more particularly the male hitch member 140) can then be inserted into a vehicle's hitch receiver VHR and secured using securing pin 400 and securing bolt 540 (see FIG. 13) thereby storing the hitch parallel to the vehicle's rear bumper RB as shown in FIG. 1.

Thus, when the vehicle owner or operator (not shown) desires to store the vehicle's hitch, the operator first inserts the hitch (represented by tri-ball hitch TBH) into the hitch storage device 100, and more particularly into the female hitch-receiving member 160 of hitch storage device 100. Once the hitch is inserted into the female hitch-receiving member 160, the male hitch member 140 is inserted into the vehicle's receiver VHR and locked in place by a securing pin 400 and securing bolt 540.

It will be appreciated by a person of ordinary skill in the art that a range of hitch storage devices 100 can be made to suit various sizes of vehicle hitch receivers VHRs and complementary sized hitches such as but not limited to, difference size tri-ball hitches TBH. More specifically, the hitch storage device 100 can be made with predetermined dimensions particularly with respect to the male hitch member 140 thereby providing a range of hitch storage devices 100 to work with a range of different sized vehicle hitch receivers VHRs. Likewise with respect to the dimensions of the female hitch member 160 which can be made in various sizes to store different sized hitches. But in each case, the hitch storage device 100 is designed to have a C_{MAX} that ensures that hitch-securing member 180 remains a permanent part of the hitch storage device 100, while permitting easy removal of a hitch (such as, but not limited to, TBH as shown in FIG. 2) from the female hitch member 160.

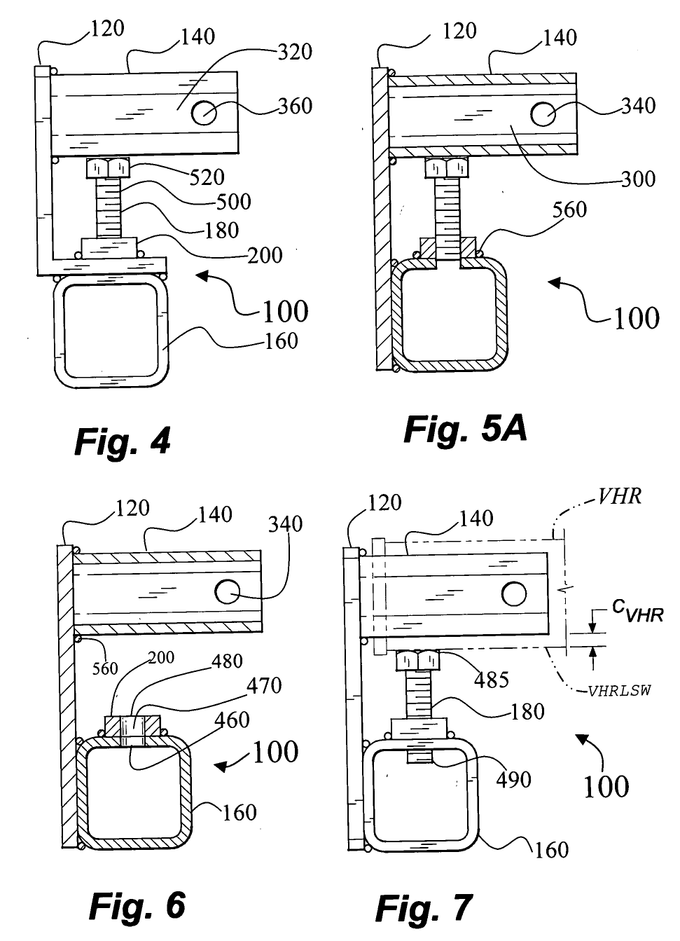

The exact structure and layout of the connecting member 120 can vary without detracting from the spirit of the invention. For example, connecting member 120 can take the form of a generally planar base plate as shown, e.g., in FIGS. 2, 3, 5A, 5B, 6, and 7. Alternatively, the connecting member 120 can take the form of an L-bracket as shown in FIGS. 4 and 9, or as a T-bracket as shown in FIG. 11. The female hitch member 160 can be positioned below the L-bracket version of itself as shown in FIG. 4 or above the L-bracket version of itself as shown in FIG. 9.

The structure of the female hitch member 160 can vary. The female hitch member 160 can take the form of a tubular elongated member having a hollow bore 420 and four sides as shown in, e.g., FIGS. 1, 2, 3, 5, 5A, 5B, 6 and 7. Alternatively, the female hitch member 160 can take the form of a generally elongated U-shaped bracket with three sides, wherein the fourth side is provided by the second surface 240 of connecting member 120 (see FIG. 10). More specifically, the generally elongated U-shaped bracket version of member 160 has its open side attached flush to the second surface 240 as shown in FIG. 10.

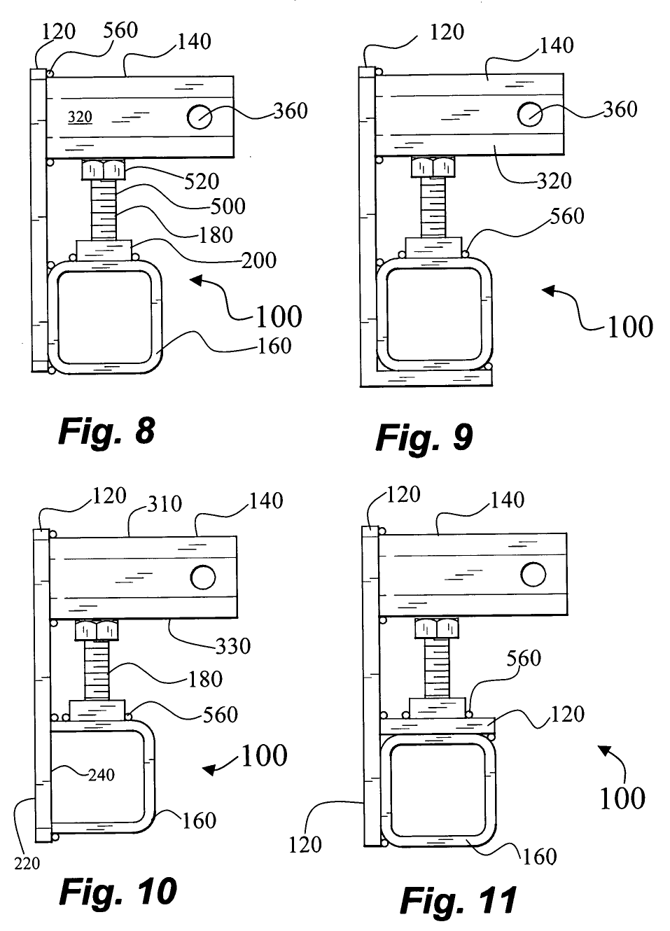

The components that make up hitch storage device 100 can be made of steel, but any material that is sufficiently durable may be used. For example, members connecting member 120, male hitch member 140, and female hitch member 160 can be made of a suitable gauge steel and welded together by at least one weld 560 (see, e.g., FIGS. 5, 5B, 6, 8, 9, and 11). The various parts of the hitch storage device 100 can be attached to each other by any suitable means such as epoxy-based adhesive or by at least one weld. For example, female hitch member 160 can be welded to the second surface 240 of connecting member 120.

In one aspect of the invention, a hitch storage device (100), comprises: a connecting member (120) having a first surface (220) and a second surface (240); a male hitch member (140) protruding outwards from and connected to the second surface (240); a female hitch member (160) connected to the second surface (240); and a hitch-securing member (180) attached to the female hitch member (160). The male hitch member (140) and the female hitch member (160) when looked at from above are perpendicular to each other. The maximum distance between the hitch-securing member (180) and the male hitch member (140) is a predetermined distance C_{MAX} so chosen to ensure that the hitch-securing member (180) cannot separate completely from the female hitch member (160). The connecting member can be any suitable connecting member such as, but not limited to, a generally planar base plate, an L-bracket, or a T-bracket.

A design, symbol, number, light, decoration or application may be adhered to, engraved, built-in, affixed in some way to the surface of 220 for design, marketing, usefulness, or aesthetics.

It is to be understood that the present invention is not limited to the embodiments described above, but encompasses any and all embodiments within the scope of the following claims.

I claim:

1. A hitch storage device (100) comprising:
a connecting member (120) having a first surface (220) and a second surface (240);
a male hitch member (140) protruding outwards from and connected to said second surface (240);
a female hitch member (160) connected to said second surface (240); and
a hitch-securing member (180) attached to said female hitch member (160),
wherein said male hitch member (140) and said female hitch member (160) when looked at from above are perpendicular to each other, and wherein the maximum distance between said hitch-securing member (180) and said male hitch member (140) is a predetermined distance C_{MAX} so chosen to ensure that said hitch-securing member (180) cannot separate completely from said female hitch member (160).

2. The hitch storage device (100) according to claim 1, wherein said connecting member is a generally planar base plate.

3. The hitch storage device (100) according to claim 1, wherein said connecting member is an L-bracket.

4. The hitch storage device (100) according to claim 1, wherein said connecting member is a T-bracket.
